(19) United States
(12) Patent Application Publication
(10) Pub. No.: US 2003/0189892 A1
(43) Pub. Date: Oct. 9, 2003

(54) ARQ apparatus and method using frequency diversity in an OFDM mobile communication system

(75) Inventors: Jung-Je Son, Songnam-shi (KR); Dae-Eop Kang, Seoul (KR); Dae-Sik Hong, Seoul (KR); Eun-Seok Ko, Seoul (KR); Pan-Yuh Joo, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/291,972

(22) Filed: Nov. 12, 2002

(30) Foreign Application Priority Data
Nov. 10, 2001 (KR) 69995/2001

(51) Int. Cl. H04J 11/00

(52) U.S. Cl. 370/208; 370/210

(57) ABSTRACT

A transmission method and apparatus in a mobile communication system, which modulates input data with a specific size into an OFDM symbol before transmission. In the transmission apparatus, a controller determines to transmit replica data instead of the input data, if the input data is retransmission data. A replica generator generates replica data by cyclically-circulating the input data under the control of the controller. An IFFT block generates an OFDM symbol by IFFT-transforming the replica data.

### PRIORITY

This application claims priority to an application entitled “ARQ Apparatus and Method Using Frequency Diversity in an OFDM Mobile Communication System” filed in the Korean Industrial Property Office on Nov. 10, 2001 and assigned Serial No. 2001-69995, the contents of which are hereby incorporated by reference.

### BACKGROUND OF THE INVENTION

1. Field of the Invention

The present invention relates generally to an OFDM (Orthogonal Frequency Division Multiplexing) mobile communication system, and in particular, to an apparatus and method for retransmitting data using frequency diversity.

2. Description of the Related Art

During downlink data communication in a mobile communication system, a UE (User Equipment) is assigned a downlink channel such as a dedicated channel (DCH) from a UTRAN (UMTS Terrestrial Radio Access Network), e.g., a Node B, and receives data over the assigned downlink channel. The mobile communication system includes a satellite system, an ISDN (Integrated Services Digital Network) system, a digital cellular system, a W-CDMA (Wideband-Code Division Multiple Access) system, a UMTS (Universal Mobile Telecommunications System) system, and an IMT-2000 (International Mobile Telecommunication-2000) system. The UE, if having correctly received packet data, transmits the received packet data to an upper layer. However, if defective packet data is received, the UE transmits a retransmission request for the defective packet data using an ARQ (Automatic Repeat Request) technique. The ARQ is a technique for sending a retransmission request for received packet data upon detecting an error in the received packet data.

A brief description of the ARQ technique will be made herein below.

The UE first receives initial packet data over a dedicated channel established by the Node B, and then determines whether an error occurs in the received initial packet data. If it is determined that an error occurs in the received initial packet data, the UE transmits a NACK signal, or a retransmission request signal for the initial packet data, to the Node B. The retransmission request signal NACK includes packet identification information, and the packet identification information includes a version number and a sequence number for the packet data. Thus, the Node B can identify information on the packet data to be retransmitted as soon as it receives the retransmission request. Upon receiving a retransmission request signal NACK transmitted by the UE, the Node B retransmits retransmission packet data corresponding to the retransmission request signal NACK to the UE over the same dedicated channel as the dedicated channel used for transmitting the initial packet data. However, if normal packet data is received, i.e., an error-free packet data is received, the UE transmits an acknowledgement signal ACK with packet identification information to the Node B. That is, the UE repeats the retransmission until it transmits an ACK signal after normal decoding, or repeats the retransmission as many times as a predetermined number of retransmissions. Here, the number of retransmissions is previously set in the system, and the UE can retransmit the defective packet data as many times as the preset number of retransmissions.

Conventionally, the ARQ is performed in a MAC (Medium Access Control) layer of the mobile communication system based on time diversity. However, this method has a limitation in increasing data transmission efficiency. Recently, therefore, research has been conducted on a method of enabling a physical layer to perform the ARQ so that a transmission side, or a Node B, can immediately recognize whether a reception side, or a UE, has correctly received packet data. In addition, a method of reducing a data rate is combined with the ARQ in order to improve error correction capability for transmission packet data, thereby contributing to a decrease in transmission error of the packet data. Since such a retransmission technique for improving error correction capability has higher retransmission efficiency compared with the existing ARQ, the ARQ has recently been applied to the physical layer in order to transmit high-speed data. However, since the ARQ used for improving the error correction capability inevitably causes a reduction in a data rate, there is a limitation in improving the overall data rate of the system.

Accordingly, there is a demand for a method of improving efficiency of the ARQ without causing a reduction in the overall data rate of the system. Such a method is required particularly in a future mobile communication system, which transmits a large amount of high-speed data. In addition, an OFDM (Orthogonal Frequency Division Multiplexing) technique using multiple carriers has recently been applied to a mobile communication system in order to transmit a large amount of high-speed data. A mobile communication system using the OFDM technique (hereinafter, referred to as an “OFDM mobile communication system”), to which the ARQ is applied, will be described with reference to FIG. 1.

FIG. 1 schematically illustrates a structure of an OFDM mobile communication system supporting the ARQ. Referring to FIG. 1, the OFDM mobile communication system includes a transmitter and a receiver. The transmitter is comprised of a physical layer ARQ controller 111, an IFFT (Inverse Fast Fourier Transform) block 113, and an RF (Radio Frequency) processor 115, and the receiver is comprised of a physical layer ARQ controller 117, an FFT (Fast Fourier Transform) block 119 and an RF processor 121. The physical layer ARQ controller 111 controls the overall transmission operation of the transmitter. If there is data to be retransmitted in the OFDM mobile communication system, the physical layer ARQ controller 111 controls retransmission of the corresponding data based on the ARQ. The IFFT block 113 IFFT-transforms output signals of the physical layer ARQ controller 111, for frequency division multiplexing, and provides its output to the RF processor 115. The RF processor 115 converts an output signal of the IFFT block 113 into an RF signal, and transmits the RF signal over the air.

The signal transmitted over the air by the transmitter is applied to the RF processor 121. The RF processor 121 RF-processes the received signal, and provides its output to the FFT block 119. The FFT block 119 FFT-transforms an output signal of the RF processor 121, and provides its output to the physical layer ARQ controller 117. The physical layer ARQ controller 117 checks whether the received signal has an error. If the received signal has an error, the physical layer ARQ controller 117 transmits a retransmission request signal NACK for requesting retransmission of the received signal, to the physical layer ARQ controller 111 over a feedback channel 123. However, if the received signal has no error, the physical layer ARQ controller 117 transmits an acknowledgement signal ACK indicating that the received data is error-free, to the physical layer ARQ controller 111 over the feedback channel 12.

Upon receiving the retransmission request signal NACK transmitted from the physical layer ARQ controller 117 over the feedback channel 123, the physical layer ARQ controller 111 performs retransmission on the retransmission-requested signal.

However, even in the OFDM mobile communication system supporting the ARQ, an increase in retransmission efficiency unavoidably causes a decrease in the overall data rate. Accordingly, there is demand for a new retransmission technique for preventing a reduction in the overall data rate of the system while increasing the retransmission efficiency.

### SUMMARY OF THE INVENTION

It is, therefore, an object of the present invention to provide an apparatus and method for retransmitting data using frequency diversity in an OFDM mobile communication system.

It is another object of the present invention to provide a data retransmission apparatus and method for maintaining an overall system data rate while maintaining retransmission efficiency in an OFDM mobile communication system.

To achieve the above and other objects, there is provided a transmission apparatus in a mobile communication system, which modulates input data with a specific size into an OFDM symbol before transmission. In the transmission apparatus, a controller determines whether to transmit replica data instead of the input data, if the input data is retransmission data. A replica generator generates replica data by cyclically-circulating the input data under the control of the controller. An IFFT block generates an OFDM symbol by IFFT-transforming the replica data.

To achieve the above and other objects, there is provided a reception apparatus for receiving a signal in a mobile communication system, which modulates input data with a specific size into an OFDM symbol before transmission. In the reception apparatus, an FFT block generates an OFDM symbol by FFT-transforming the received signal. A controller determines whether the OFDM symbol is retransmission data, and if the OFDM symbol is retransmission data, the controller determines whether the retransmission data is replica data. Further, if the transmission data is replica data, the controller modulates the replica data by a frequency diversity technique. A frequency diversity combiner modulates the input data by inversely cyclically-circulating the replica data under the control of the controller.

To achieve the above and other objects, there is provided a transmission method in a mobile communication system, which modulates input data with a specific size into an OFDM symbol before transmission. The method comprises determining whether to transmit replica data instead of the input data, if the input data is retransmission data; generating replica data by cyclically-circulating the input data after the determination; and generating an OFDM symbol by IFFT-transforming the replica data.

To achieve the above and other objects, there is provided a reception method for receiving a signal in a mobile communication system, which modulates input data with a specific size into an OFDM symbol before transmission. The method comprises generating an OFDM symbol by FFT-transforming the received signal; determining whether the OFDM symbol is retransmission data; if the OFDM symbol is retransmission data, determining whether the retransmission data is replica data; if the transmission data is replica data, modulating the replica data by a frequency diversity technique; and modulating the input data by inversely cyclically-circulating the replica data according to the frequency diversity technique.

### BRIEF DESCRIPTION OF THE DRAWINGS

The above and other objects, features, and advantages of the present invention will become more apparent from the following detailed description when taken in conjunction with the accompanying drawings in which:

FIG. 1 schematically illustrates a structure of a conventional OFDM mobile communication system supporting the ARQ;

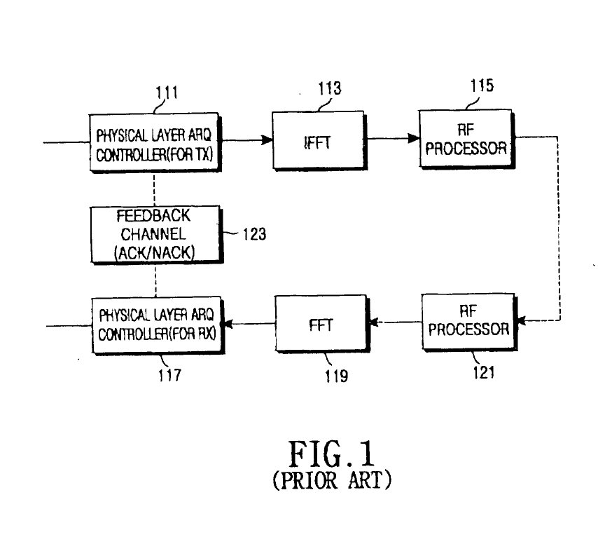

FIG. 2 schematically illustrates a structure of an OFDM mobile communication system supporting the ARQ according to an embodiment of the present invention;

FIG. 3 illustrates a detailed structure of the replica generator illustrated in FIG. 2;

FIG. 4 is a flowchart illustrating an operation of a transmitter in the OFDM mobile communication system illustrated in FIG. 2;

FIG. 5 is a flowchart illustrating an operation of a receiver in the OFDM mobile communication system illustrated in FIG. 2;

FIG. 6 is a flowchart illustrating an operation of the replica generator illustrated in FIG. 2;

FIG. 7 is a flowchart illustrating operations of the transmitter and the receiver in the OFDM mobile communication system illustrated in FIG. 2; and

FIG. 8 is a block diagram illustrating a detailed structure of the frequency diversity combiner illustrated in FIG. 2.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

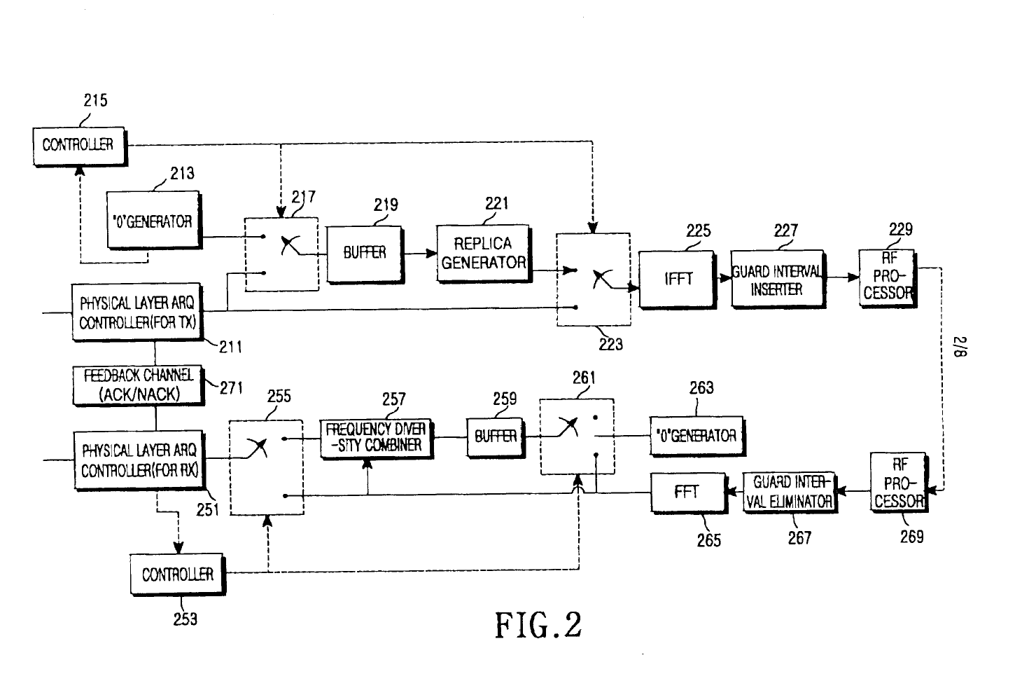

FIG. 2 schematically illustrates a structure of an OFDM mobile communication system supporting ARQ according to an embodiment of the present invention. Referring to FIG. 2, the OFDM mobile communication system includes a transmitter and a receiver. The transmitter is comprised of a physical layer ARQ (Automatic Repeat Request) controller 211, a zero (0) generator 213, a controller 215, a first switch 217, a buffer 219, a replica generator 221, a second switch 223, an IFFT (Inverse Fast Fourier Transform) block 225, a guard interval inserter 227, and an RF (Radio Frequency) processor 229. The receiver is comprised of a physical layer ARQ controller 251, a controller 253, a third switch 255, a frequency diversity combiner 257, a buffer 259, a fourth switch 261, a zero generator 263, an FFT (Fast Fourier Transform) block 265, a guard interval eliminator 267, and an RF processor 269.

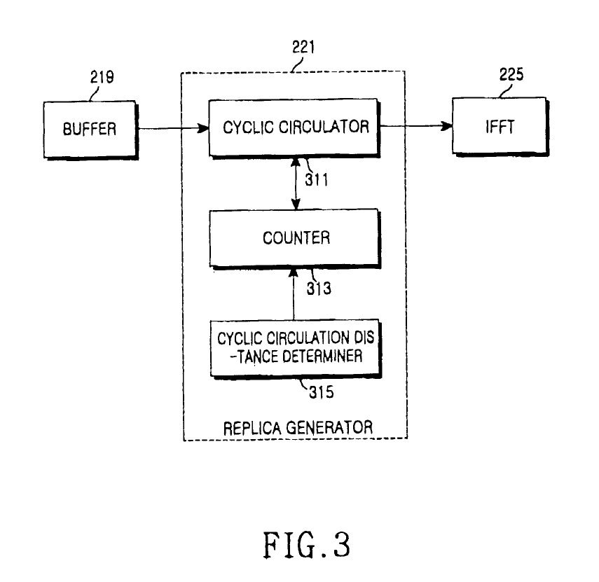

First, a structure of the transmitter will be described in detail. The physical layer ARQ controller 211 controls the overall transmission operation of the transmitter. If there is data to be retransmitted in the OFDM mobile communication system, the physical layer ARQ controller 211 determines whether it will retransmit the corresponding data based on the general ARQ or it will retransmit the corresponding data using a replica generated by cyclic circulation. The physical layer ARQ controller 211 provides the determined retransmission method to the controller 215 so that the corresponding data, i.e., the retransmission-requested data, can be transmitted in the determined retransmission method. The controller 215 controls switching operations of the first switch 217 and the second switch 223 according to the retransmission method determined by the physical layer ARQ controller 211. The zero generator 213, under the control of the controller 215, generates as many 0's as a predetermined number d over a symbol by QAM (Quadrature Amplitude Modulation)/QPSK (Quadrature Phase Shift Keying) mapping, in order to prevent a transmission delay that occurs during data transmission using a replica generated by the cyclic circulation from being longer than a transmission delay that occurs during data transmission not using the replica generated by the cyclic circulation. The buffer 219 buffers an output signal of the first switch 217. The replica generator 221 generates a replica by cyclically-circulating the symbols buffered in the buffer 219 at predetermined periods, i.e., at periods of one OFDM symbol, and provides the generated replica to the second switch 223. A detailed operation of the replica generator 221 will be described later on with reference to FIG. 3.

An output signal of the replica generator 221 is provided to the IFFT block 225 through the second switch 223. The IFFT block 225 IFFT-transforms an output signal of the second switch 223, for frequency division multiplexing, and provides its output to the guard interval inserter 227. The guard interval inserter 227 inserts a guard interval into an output signal of the IFFT block 225, and provides its output to the RF processor 229. Here, the guard interval is inserted in order to minimize inter-symbol interference (ISI) between the OFDM symbols. The RF processor 229 converts an output signal of the guard interval inserter 227 into an RF signal, and transmits the RF signal over the air.

Next, a structure of the receiver will be described in detail.

The signal transmitted over the air by the transmitter is applied to the RF processor 269. The RF processor 269 RF-processes the received signal, and provides its output to the guard interval eliminator 267. The guard interval eliminator 267 receives an output signal of the RF processor 269, eliminates a guard interval included therein, and provides its output to the FFT block 265. The FFT block 265 FFT-transforms an output signal of the guard interval eliminator 267, and provides its output to the third switch 255 and the fourth switch 261. If an output signal of the FFT block 265 is an initially transmitted signal, the fourth switch 261 is switched on to provide the output signal of the FFT block 265 to the buffer 259. The buffer 259 then buffers the received signal provided from the switch 261. The physical layer ARQ controller 251 receives the signal stored in the buffer 259 at predetermined periods, and determines whether the received signal has an error. If the received signal has an error, the physical layer ARQ controller 251 transmits a retransmission request signal NACK for requesting retransmission of the received signal, to the physical layer ARQ controller 211 over a feedback channel 271. The third switch 255 and the fourth switch 261 are controlled by the controller 253. Further, the physical layer ARQ controller 251 can determine whether the received signal is an initially transmitted signal or a retransmitted signal.

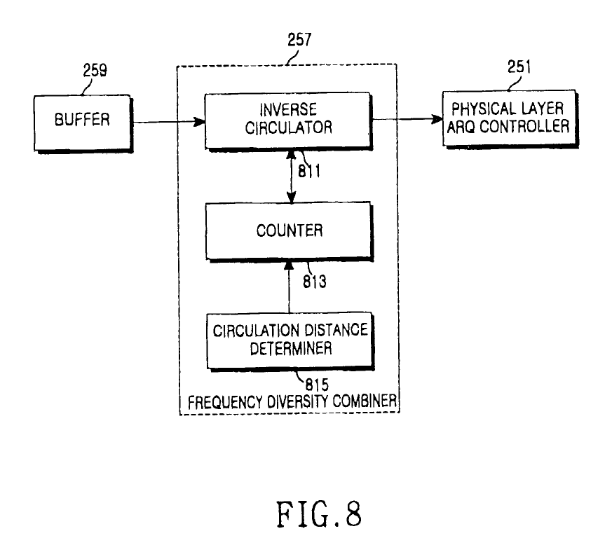

However, if the received signal provided from the FFT block 265 is not an initially transmitted signal but a retransmitted signal, the physical layer ARQ controller 251 provides the controller 253 with a control signal for inserting 0's into the received retransmitted signal in order to prevent an output signal of the FFT block 265, if it is not a cyclic circulation-based retransmission signal, from being delayed against the cyclic circulation-based retransmission signal. The controller 253 then generates the output data of the FFT block 265 by controlling the fourth switch 261, and enables the zero generator 263 for a predetermined number d of symbols, where d is previously determined to prevent the transmission delay. Of course, if the output signal of the FFT block 265 is a cyclic circulation-based retransmission signal, the controller 253 disables the zero generator 263. The transmitted signal is provided to the frequency diversity combiner 257 after being buffered by the buffer 259. Further, in order to apply frequency diversity to the retransmission signal, the physical layer ARQ controller 251 provides the controller 253 with a control signal for enabling the frequency diversity combiner 257. The controller 253 then applies frequency diversity to the retransmission signal output from the buffer 259, and provides the signal to the physical layer ARQ controller 251. A detailed structure of the frequency diversity combiner 257 will be described in detail later with reference to FIG. 8. The physical layer ARQ controller 251 combines the retransmission data with the initial transmission data previously buffered in the buffer 259, and finally decodes the combined data. The physical layer ARQ controller 251 determines whether to perform the retransmission operation again, according to whether the combined data has an error.

Next, an internal structure of the replica generator 221 will be described with reference to FIG. 3.

FIG. 3 illustrates a detailed structure of the replica generator 221 illustrated in FIG. 2. Referring to FIG. 3, a signal output from the buffer 219 at predetermined periods, i.e., at periods of one OFDM symbol is applied to the replica generator 221 as described in conjunction with FIG. 2. The output signal of the buffer 219 is a signal that has undergone QAM/QPSK mapping and scrambling. The replica generator 221 is comprised of a cyclic circulator 311, a counter 313, and a cyclic circulation distance determiner 315. The cyclic circulation distance determiner 315 determines a cyclic circulation distance “d” (or an amount of cyclic circulation) of an OFDM symbol output from the buffer 219. The counter 313 counts the cyclic circulation distance d determined by the cyclic circulation distance determiner 315. The cyclic circulator 311 cyclically-circulates an OFDM symbol stored in the buffer 219 based on the cyclic circulation distance d determined by the cyclic circulation distance determiner 315. That is, the cyclic circulator 311 cyclically-circulates an OFDM symbol output from the buffer 219 by the cyclic circulation distance d output from the counter 313.

Now, a process of cyclically-circulating an OFDM symbol “s” output from the buffer 219 by the cyclic circulator 311 will be described herein below.

The OFDM symbol s is represented by

s=[s(0) . . . s(N−1)]^{T} Equation (1)

In Equation (1), N denotes the total number of subcarriers used in the OFDM mobile communication system and T is a transpose.

In the OFDM mobile communication system supporting the ARQ, in order to prevent a decrease in reliability of retransmission due to transmission over the same path, the present invention performs cyclic circulation on subcarriers, producing the diversity effect. To this end, in the OFDM mobile communication system, replicas must be transmitted over subcarriers having no correlation with one another. A symbol s′ generated by cyclically-circulating the OFDM symbol is expressed as

s′=[s(N−d) . . . s(N−1)s(0) . . . s(N−d−1)]^{T} Equation (2)

In Equation (2), the cyclic circulation distance d is calculated by

$$d = ⌊ \frac{N}{L} ⌋ \cdot ⌊ \frac{L}{2} ⌋ \qquad Equation ( 3 )$$

In Equation (3), L denotes the number of multiple paths of a selective frequency fading channel.

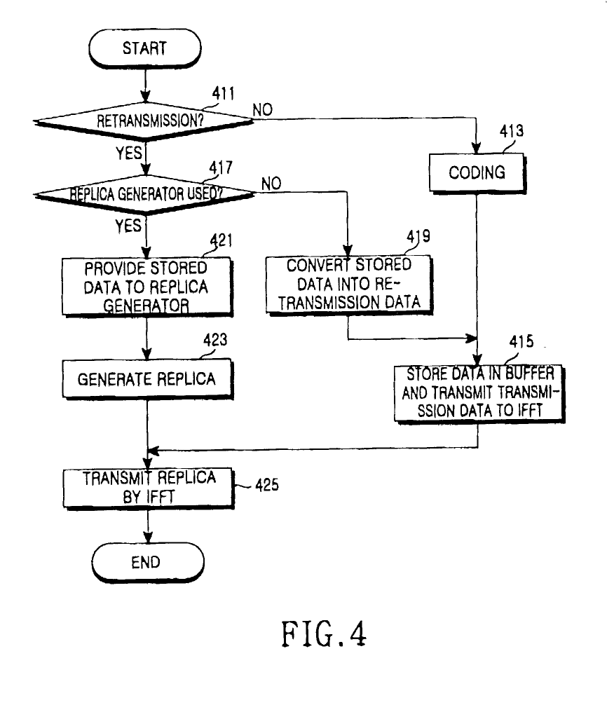

Next, an operation of a transmitter in the OFDM mobile communication system supporting the ARQ will be described with reference to FIG. 4.

FIG. 4 is a flowchart illustrating an operation of a transmitter in the OFDM mobile communication system illustrated in FIG. 2. Referring to FIG. 4, if there is transmission data, the physical layer ARQ controller 211 determines in step 411 whether the transmission data is retransmission data. If the transmission data is not retransmission data, but initial transmission data, the physical layer ARQ controller 211 proceeds to step 413. In step 413, the physical layer ARQ controller 211 encodes the transmission data by a predetermined coding technique, and then proceeds to step 415. In step 415, the physical layer ARQ controller 211 provides the controller 215 with a control signal for switching on the first switch 217 to store the coded transmission data in the buffer 219, and switching on the second switch 223 to provide the transmission data to the IFFT block 225.

However, if it is determined in step 411 that the transmission data is retransmission data, the physical layer ARQ controller 211 determines in step 417 whether to use the replica generator 221 for the retransmission data. If the physical layer ARQ controller 211 determines not to use the replica generator 221 for the retransmission data, i.e., if the physical layer ARQ controller 211 determines to use the general ARQ, the physical layer ARQ controller 211 proceeds to step 419. In step 419, the physical layer ARQ controller 211 converts the data stored in the buffer 219, i.e., the initially transmitted data, into retransmission data, and then proceeds to step 415.

Otherwise, if it is determined in step 417 that the physical layer ARQ controller 211 determines to use the replica generator 221, the physical layer ARQ controller 211 proceeds to step 421. In step 421, the physical layer ARQ controller 211 provides the data stored in the buffer 219, i.e., the initially transmitted data, to the replica generator 221, and then proceeds to step 423. In step 423, the replica generator 221 generates a replica by cyclically-circulating output data of the buffer 219 by a cyclic circulation distance d, provides the generated replica to the IFFT block 225, and then proceeds to step 425. In step 425, the IFFT block 225 retransmits the generated replica, and then ends the process.

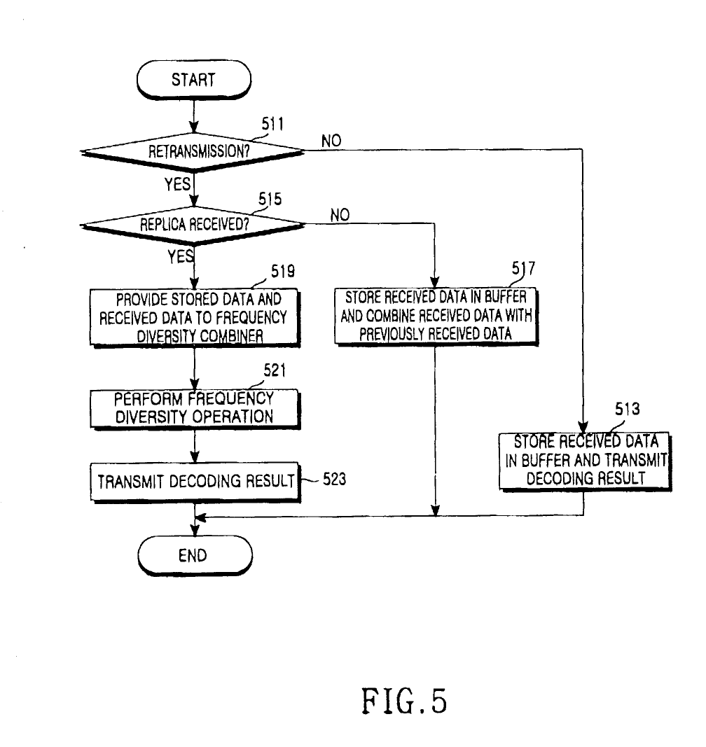

Next, an operation of a receiver in the OFDM mobile communication system supporting the ARQ will be described with reference to FIG. 5.

FIG. 5 is a flowchart illustrating an operation of a receiver in the OFDM mobile communication system illustrated in FIG. 2. Referring to FIG. 5, if data is received, the physical layer ARQ controller 251 determines in step 511 whether the received data is retransmission data. As a result of the determination, if the received data is not retransmission data, the physical layer ARQ controller 251 proceeds to step 513. In step 513, the physical layer ARQ controller 251 stores the received data, i.e., the initial transmission data, in the buffer 259, decodes the received data, and based on the decoding results, transmits a retransmission request signal NACK or an acknowledgement signal ACK to the physical layer ARQ controller 211.

However, if it is determined in step 511 that the received data is retransmission data, the physical layer ARQ controller 251 determines in step 515 whether the retransmission data is a replica generated by cyclic circulation. If the retransmission data is not a replica generated by cyclic circulation, the physical layer ARQ controller 251 proceeds to step 517. In step 517, the physical layer ARQ controller 251 stores the received retransmission data in the buffer 259, combines the received data with the corresponding data previously stored in the buffer 259, and based on the combining results, transmits a retransmission request signal NACK or an acknowledgement signal ACK to the physical layer ARQ controller 211.

Otherwise, if it is determined in step 515 that the retransmission data is a replica generated by cyclic circulation, the physical layer ARQ controller 251 proceeds to step 519. In step 519, the physical layer ARQ controller 251 provides the received replica and the corresponding data stored in the buffer 259 to the frequency diversity combiner 257 to perform a frequency diversity operation, and then proceeds to step 521. In step 521, the frequency diversity combiner 257 performs a frequency diversity operation on the received replica and the corresponding data stored in the buffer 259, and then proceeds to step 523. Here, the “frequency diversity operation” performed by the frequency diversity combiner 257 refers to a process of inversely cyclically-circulating the received retransmission data by the cyclic circulation distance d used by the replica generator 221 in the transmitter to generate replica data. That is, since the received retransmission data (or replica data) must be inversely cyclically-circulated by the cyclic circulation distance d in order to be restored to its original data, the frequency diversity combiner 257 performs the frequency diversity operation. In step 523, the physical layer ARQ controller 251 decodes the data that underwent the frequency diversity operation, checks whether the decoded data has an error, and based on the error check results, transmits a retransmission request signal NACK or an acknowledgement signal ACK to the physical layer ARQ controller 211.

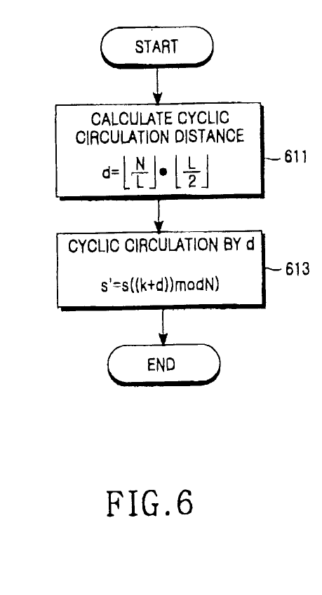

FIG. 6 is a flowchart illustrating an operation of the replica generator 221 illustrated in FIG. 2. Referring to FIG. 6, if output data of the buffer 219 is received, the replica generator 221 calculates, in step 611, a cyclic circulation distance d to be applied to the output data of the buffer 219, and then proceeds to step 613. Here, the cyclic circulation distance d is calculated in accordance with Equation (3). In step 613, the replica generator 221 cyclically-circulates the output data of the buffer 219, i.e., one OFDM symbol, by the calculated cyclic circulation distance d, and then ends the process. The cyclically-circulated data is expressed as Equation (2).

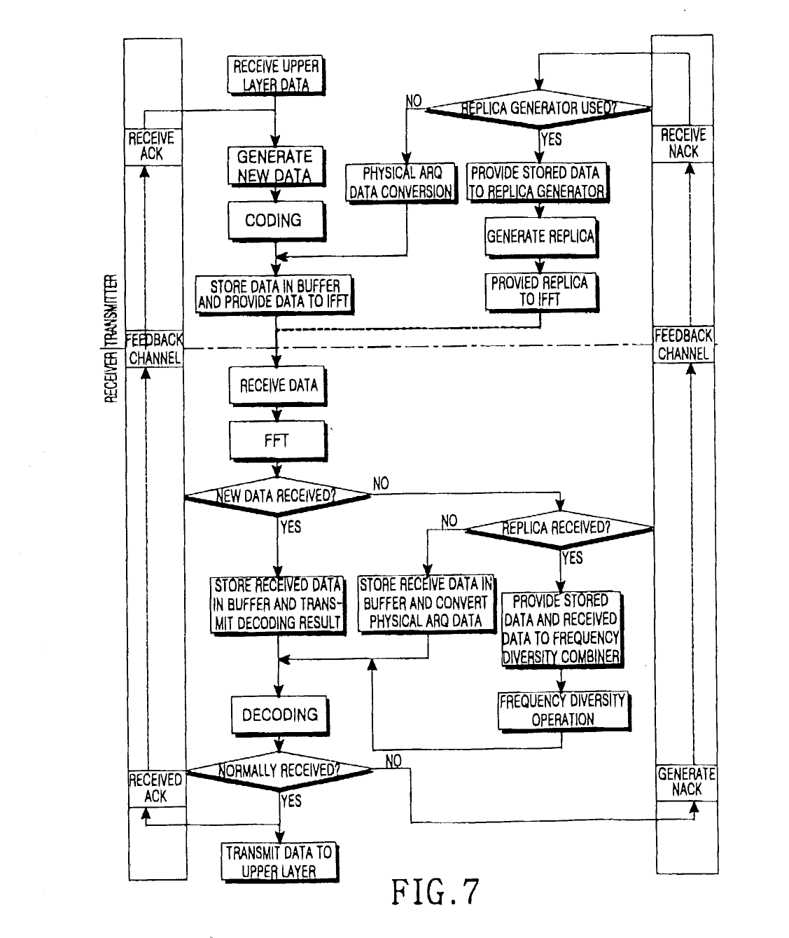

FIG. 7 is a flowchart illustrating operations of the transmitter and the receiver in the OFDM mobile communication system illustrated in FIG. 2. The operations of FIG. 7 are similar to the operations described in conjunction with FIGS. 5 and 6, except that the operation of the transmitter is separated according to whether a response signal received from the receiver is an acknowledgement signal ACK or a retransmission request signal NACK, and the operation of the receiver is separated according to whether data received from the transmitter is initial transmission data or retransmission data. Therefore, a detailed description of the operations will not be provided. In addition, FIG. 7 illustrates feedback channels established between the transmitter and the receiver, over which the acknowledgement signal ACK and the retransmission request signal NACK are transmitted.

FIG. 8 is a block diagram illustrating a detailed structure of the frequency diversity combiner 257 illustrated in FIG. 2. Referring to FIG. 8, the frequency diversity combiner 257 is comprised of an inverse cyclic circulator 811, a counter 813, and a cyclic circulation distance determiner 815. The cyclic circulation distance determiner 815 determines a cyclic circulation distance d of an OFDM symbol output from the buffer 259. Here, the cyclic circulation distance d is identical to the cyclic circulation distance d used by the transmitter. The counter 813 counts the cyclic circulation distance d output from the cyclic circulation distance determiner 815. The inverse cyclic circulator 811 inversely cyclically-circulates an OFDM symbol stored in the buffer 259 based on the cyclic circulation distance d determined by the cyclic circulation distance determiner 815, and provides its output to the physical layer ARQ controller 251. That is, the inverse cyclic circulator 811 inversely cyclically-circulates an OFDM symbol output from the buffer 259 by the cyclic circulation distance d output from the counter 813, and provides its output to the physical layer ARQ controller 251.

As described above, in the OFDM mobile communication system, the present invention performs data retransmission with cyclic circulation-based replicas, thereby acquiring not only the time diversity effect through simple data retransmission by the conventional ARQ, but also the frequency diversity effect using the retransmitted data. As a result, the data retransmission efficiency is increased. In addition, it is possible to prevent a reduction in the overall data rate of the system by transmitting the cyclic circulation-based replicas during data retransmission.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmission apparatus in a mobile communication system, which modulates input data with a specific size into an OFDM (Orthogonal Frequency Division Multiplexing) symbol before transmission, the apparatus comprising:
a controller for determining whether to transmit replica data instead of the input data, if the input data is retransmission data;
a replica generator for generating the replica data by cyclically-circulating the input data under control of the controller; and
an IFFT (Inverse Fast Fourier Transform) block for generating the OFDM symbol by IFFT-transforming the replica data.

2. The transmission apparatus of claim 1, wherein the replica generator comprises a cyclic circulator for cyclically-circulating the input data by a predetermined cyclic circulation distance.

3. The transmission apparatus of claim 2, wherein the replica generator further comprises:
a cyclic circulation distance determiner for determining the cyclic circulation distance; and
a counter for counting the determined cyclic circulation distance.

4. The transmission apparatus of claim 3, wherein the cyclic circulation distance is calculated by
$$d = ⌊ \frac{N}{L} ⌋ \cdot ⌊ \frac{L}{2} ⌋$$
where d denotes the cyclic circulation distance, N denotes a total number of subcarriers of the OFDM symbol, and L denotes a number of multiple paths.

5. The transmission apparatus of claim 1, further comprising a zero generator for generating 0's for a predetermined time period in order to remove a delay time required for cyclically-circulating the input data.

6. A reception apparatus for receiving a signal in a mobile communication system, which modulates input data with a specific size into an OFDM (Orthogonal Frequency Division Multiplexing) symbol before transmission, the apparatus comprising:
an FFT (Fast Fourier Transform) block for generating the OFDM symbol by FFT-transforming the received signal;
a controller for (a) determining whether the OFDM symbol is retransmission data, (b) if the OFDM symbol is retransmission data, determining whether the retransmission data is replica data, and (c) if the retransmission data is replica data, modulating the replica data by a frequency diversity technique; and
a frequency diversity combiner for modulating the input data by inversely cyclically-circulating the replica data under control of the controller.

7. The reception apparatus of claim 6, wherein the frequency diversity combiner comprises an inverse cyclic circulator for inversely cyclically-circulating the replica data by a predetermined cyclic circulation distance.

8. The reception apparatus of claim 7, wherein the cyclic circulation distance is calculated by
$$d = ⌊ \frac{N}{L} ⌋ \cdot ⌊ \frac{L}{2} ⌋$$
where d denotes the cyclic circulation distance, N denotes a total number of subcarriers of the OFDM symbol, and L denotes a number of multiple paths.

9. The reception apparatus of claim 6, further comprising a zero generator for generating 0's for a predetermined time period in order to remove a delay time required for cyclically-circulating the input data.

10. A transmission method in a mobile communication system, which modulates input data with a specific size into an OFDM (Orthogonal Frequency Division Multiplexing) symbol before transmission, the method comprising the steps of:
(a) determining whether to transmit replica data instead of the input data, if the input data is retransmission data;
(b) generating the replica data by cyclically-circulating the input data after the determination; and
(c) generating the OFDM symbol by IFFT (Inverse Fast Fourier Transform)-transforming the replica data.

11. The transmission method of claim 10, wherein the step (b) comprises cyclically-circulating the input data by a predetermined cyclic circulation distance.

12. The transmission method of claim 11, wherein the cyclic circulation distance is calculated by
$$d = ⌊ \frac{N}{L} ⌋ \cdot ⌊ \frac{L}{2} ⌋$$
where d denotes the cyclic circulation distance, N denotes a total number of subcarriers of the OFDM symbol, and L denotes a number of multiple paths.

13. The transmission method of claim 10, further comprising the step of generating 0's for a predetermined time period in order to remove a delay time required for cyclically-circulating the input data.

14. A reception method for receiving a signal in a mobile communication system, which modulates input data with a specific size into an OFDM (Orthogonal Frequency Division Multiplexing) symbol before transmission, the method comprising the steps of:
generating the OFDM symbol by FFT (Fast Fourier Transform)-transforming the received signal;
determining whether the OFDM symbol is retransmission data;
if the OFDM symbol is retransmission data, determining whether the retransmission data is replica data;
if the transmission data is replica data, modulating the replica data by a frequency diversity technique; and
modulating the input data by inversely cyclically-circulating the replica data according to the frequency diversity technique.

15. The reception method of claim 14, wherein the modulation step comprises inversely cyclically-circulating the replica data by a predetermined cyclic circulation distance.

16. The reception method of claim 15, wherein the cyclic circulation distance is calculated by
$$d = ⌊ \frac{N}{L} ⌋ \cdot ⌊ \frac{L}{2} ⌋$$
where d denotes the cyclic circulation distance, N denotes a total number of subcarriers of the OFDM symbol, and L denotes a number of multiple paths.

17. The reception method of claim 14, further comprising the step of generating 0's for a predetermined time period in order to remove a delay time required for cyclically-circulating the input data.
